(19) United States
(12) Patent Application Publication
(10) Pub. No.: US 2013/0036723 A1
(43) Pub. Date: Feb. 14, 2013

(54) OXY-COMBUSTION GAS TURBINE HYBRID

(71) Applicant: Craig LA FORCE, Missouri City, TX (US)

(72) Inventor: Craig LA FORCE, Missouri City, TX (US)

(73) Assignee: Air Liquide Process and Construction Inc., Houston, TX (US)

(21) Appl. No.: 13/286,679

(22) Filed: Nov. 1, 2011

Related U.S. Application Data
(60) Provisional application No. 61/521,179, filed on Aug. 8, 2011.

(51) Int. Cl. F02C 3/20; F02C 7/10; F02C 7/26; F02C 3/28

(52) U.S. Cl. 60/39.461; 60/39.12; 60/39.511; 60/787

(57) ABSTRACT

An integrated oxy-combustion power generation process is provided. This process includes providing an air separation unit for producing at least an oxygen-enriched stream, providing a carbon dioxide recycle stream, which is combined with the oxygen-enriched stream thereby producing a synthetic air stream, providing a gas turbine comprising a gas inlet , a combustor, and a gas outlet, wherein the synthetic air stream is introduced into the gas inlet, providing a fuel stream to the combustor, thereby producing a power output, and a hot exhaust gas stream, which exits the gas outlet, introducing the exhaust gas stream, along with a boiler feed water stream, into a heat recovery steam generator, thereby producing a steam stream and a cooled exhaust gas stream, and separating the cooled exhaust gas stream into an enriched carbon dioxide product stream and the carbon dioxide recycle stream.

### CROSS REFERENCE TO RELATED APPLICATIONS

This application claims the benefit under 35 U.S.C. §119 (e) to provisional application No. 61/521,179, filed Aug. 8, 2011, the entire contents of which are incorporated herein by reference.

### BACKGROUND

The products of air separation units can be used in various power generation schemes and can enhance the performance of existing power generation systems. Such products may therefore play key roles in the high-efficiency, low or zero-emission power generation schemes of the future. For example, oxygen and oxygen-enriched air have been demonstrated to enhance combustion, increase production, and reduce emissions. Oxy-combustion also has the inherent advantage of producing a CO2-rich flue gas, which can be more easily processed to produce a pure CO2 Product stream than flue gas from air-blown processes. With the increasing interest in global climate change, as well as the beneficial role CO2 can play in enhanced oil recovery, more attention will undoubtedly be focused on technologies that facilitate the capture of CO2. The greater ease with which CO2-rich flue gas produced by oxy-combustion may be processed to capture CO2 therefore suggests that the further development of this technology would be beneficial.

### SUMMARY

An integrated oxy-combustion power generation process is provided. This process includes providing:

1. an air separation unit for producing at least an oxygen-enriched stream

2. a carbon dioxide recycle stream, which is combined with the oxygen-enriched stream thereby producing a “synthetic air” stream

3. a gas turbine comprising a gas inlet , a combustor, and a gas outlet, wherein the synthetic air stream is introduced into the gas inlet

4. a fuel stream to the gas turbine combustor which is combusted with the compressed synthetic air stream, and then expanded to produce shaft power output, and a hot exhaust gas stream, exiting the gas turbine. The hot exhaust gas stream then enters the heat recovery steam generator along with boiler feed water to produce a steam stream and a cooled exhaust gas stream. The cooled exhaust gas stream which contains an enriched carbon dioxide concentration since little or no nitrogen enters the combustion process as in conventional air combustion is then divided into a recycle stream and a product stream ready to be further purified or used at the purity level that results from the oxy-combustion process (typically near 90 to 95% CO2).

### BRIEF DESCRIPTION OF THE DRAWINGS

The invention may be understood by reference to the following description taken in conjunction with the accompanying drawings, and in which:

FIG. 1 illustrates a schematic representation in accordance with one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

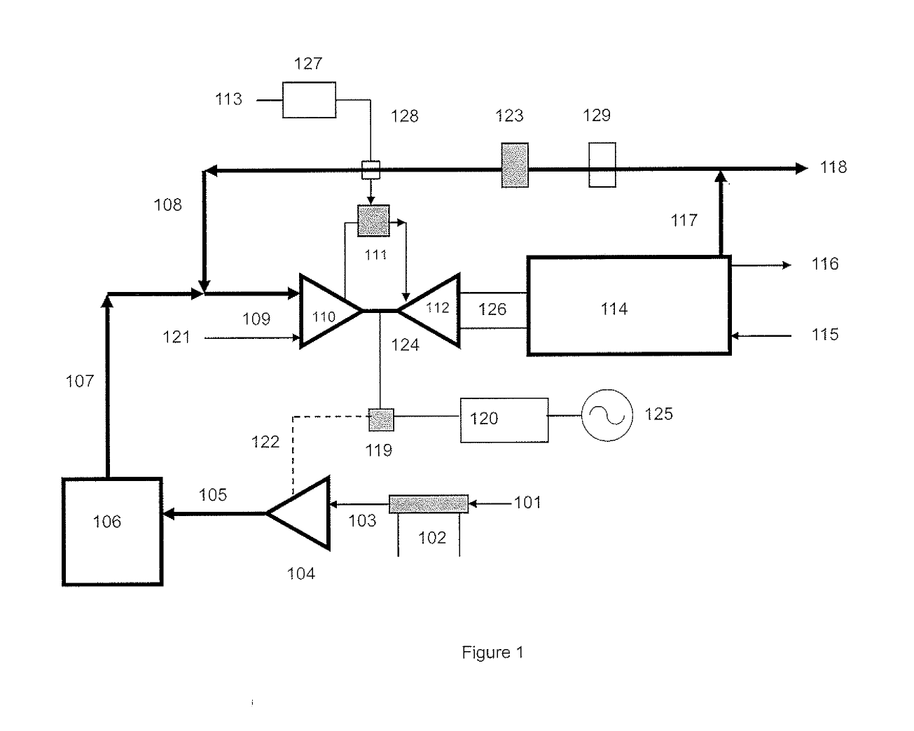

Turning now to FIG. 1, an integrated oxy-combustion power generation process and apparatus is provided. Under steady state operation, inlet air 101 is introduced into inlet air filter 102. Filtered air stream 103 then enters main air compressor (MAC) 104, wherein this filtered inlet air is pressurized into feed stream 105. Feed stream 105 then enters air separation unit 106. Air separation unit 106 may be of any appropriate design known in the art. Air separation unit 106 produces at least oxygen-enriched stream 107. Oxygen-enriched stream 107 may have a purity of greater than 97%.

Oxygen-enriched stream 107 is then blended with carbon dioxide-enriched recycle stream 108 (discussed below), thereby producing synthetic air stream 109. Synthetic air stream 109 may contain small amounts of water and excess oxygen. The ratio of oxygen to carbon dioxide may be varied thereby providing design flexibility (impacting molecular weight, temperatures throughout the gas turbine and mass flow through the unit), the recycle stream may be recycled at flue gas temperatures (above the dewpoint of water to potentially increase efficiency and avoid corrosion concerns of wet CO2,or as a stream that is cooled to near ambient temperature). The molecular weight of the synthetic air will ordinarily be greater than atmospheric air, and also have a different heat capacity. Both these variables may impact the design and optimal operating pressure of the gas compressor-turbine aerodynamic components, which are readily calculated by known compressor technology, avoiding the need for undue experimentation.

Synthetic air stream 109 is introduced to compressor section 110 of gas turbine 124. Fuel stream 113 may be directly introduced into combustor 111 of gas turbine 124, which then produces a combustion stream. Fuel stream 113 may be pretreated 127 to produce a pretreated fuel stream 128 substantially free of nitrogen. This combustion stream is introduced into turbine section 112 of gas turbine 124, thereby producing a net power production and hot exhaust gas stream 126. Net power production is directed through gearbox 119 and then, at least a portion of this power, is directed to generator 120. Generator 120 then produces power output 125.

Hot exhaust gas stream 126 is directed to heat recovery steam generator 114, which takes boiler feed water stream 115 and produces steam stream 116. After the heat exchange within heat recovery steam generator 114, hot exhaust gas stream 126 is cooled and exits as cooled exhaust gas stream 117. Cooled exhaust gas stream 117 may have a carbon dioxide purity of over 93%. A first portion of cooled exhaust gas stream 117 may be exported as enriched carbon dioxide product stream 118, and a second portion may be cooled in cooler 129 and/or dried in drier 123, after which it becomes carbon dioxide-enriched recycle stream 108.

In one embodiment, air inlet stream 121 may be added to compressor section 110 of gas turbine 124, during start up. Then once steady state operation has been achieved, air inlet stream 121 may be switched for synthetic air stream 109. The use of air inlet stream 121 may be continued should the ASU trip, or be out of commission for planned or unplanned outages.

In one embodiment, a portion 122 of the net power may be directed through gearbox 119 and used to power MAC 104. This embodiment eliminates the capital and operating cost of a MAC motor.

The invention provides several improvements to a typical combined cycle plant's efficiency. It offers the designer the potential for reducing, or eliminating, stack losses. It offers design freedom to adjust the molecular weight of the combustion stream (synthetic air) by adjusting the amount of carbon dioxide that is recycled. It provides the potential for a zero NOx emission cycle, and gives design freedom to increase the pressure and temperature of the gas turbine. If the fuel is pretreated to remove substantially all the nitrogen, the gas turbine cycle can operate at higher combustion temperatures, thereby improving the Carnot cycle efficiency, without forming NOx.

it will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. An integrated oxy-combustion power generation process comprising:
a) providing an air separation unit for producing at least an oxygen-enriched stream,
b) providing a carbon dioxide recycle stream, which is combined with said oxygen-enriched stream thereby producing a synthetic air stream,
c) providing a gas turbine comprising a gas inlet, a combustor, and a gas outlet, wherein said synthetic air stream is introduced into said gas inlet,
d) providing a fuel stream to said combustor, thereby producing a power output, and a hot exhaust gas stream, which exits said gas outlet,
e) introducing said exhaust gas stream, along with a boiler feed water stream, into a heat recovery steam generator, thereby producing a steam stream and a cooled exhaust gas stream, and
f) separating said cooled exhaust gas stream into an enriched carbon dioxide product stream and said carbon dioxide recycle stream.

2. The integrated oxy-combustion power generation process of claim 1, wherein said carbon dioxide recycle feed stream is dried prior to being combined with said oxygen-enriched stream.

3. The integrated oxy-combustion power generation process of claim 2, wherein said carbon dioxide recycle stream is cooled prior to being dried.

4. The integrated oxy-combustion power generation process of claim 1, wherein said cooled exhaust gas stream has a carbon dioxide purity of over 93%.

5. The integrated oxy-combustion power generation process of claim 1, wherein said oxygen-enriched stream has a purity of greater than 97%.

6. The integrated oxy-combustion power generation process of claim 1, further comprising an air inlet stream, wherein said gas turbine operates on said inlet air stream during start up, and switches to operating with said oxygen-enriched stream during steady-state operation.

7. The integrated oxy-combustion power generation process of claim 6, wherein said gas turbine operates on said inlet air stream when the air separation unit is inoperative.

8. The integrated oxy-combustion power generation process of claim 1, wherein said air separation unit further comprises a main air compressor, and at least a portion of said gas turbine power output is used to power said main air compressor.

9. The integrated oxy-combustion power generation process of claim 1, wherein said fuel stream is pretreated to remove substantially all nitrogen.

10. An integrated oxy-combustion power generation apparatus comprising:
a) an air separation unit for producing at least an oxygen-enriched stream,
b) a conduit for providing a carbon dioxide recycle stream, which is combined with said oxygen-enriched stream thereby producing a synthetic air stream,
c) a gas turbine comprising a gas inlet, a combustor, and a gas outlet,
d) a conduit for admitting said synthetic air stream is introduced into said gas inlet,
e) a conduit for providing a fuel stream to said combustor, thereby producing a power output, and a hot exhaust gas stream, which exits said gas outlet,
f) a heat recovery steam generator,
g) a conduit for providing said exhaust gas stream, along with a boiler feed water stream, into said heat recovery steam generator, thereby producing a steam stream and a cooled exhaust gas stream, and
h) a separator for separating said cooled exhaust gas stream into an enriched carbon dioxide product stream and said carbon dioxide recycle stream.

11. The integrated oxy-combustion power generation apparatus of claim 10, further comprising a dryer situated between said separator and said conduit for admitting said synthetic air stream is introduced into said gas inlet.

12. The integrated oxy-combustion power generation apparatus of claim 11, further comprising a heat exchanger situated between said separator and said dryer.

13. The integrated oxy-combustion power generation apparatus of claim 10, further comprising a conduit for an air inlet stream to enter said gas turbine.

14. The integrated oxy-combustion power generation apparatus of claim 10, further comprising a main air compressor in said air separation unit.
